(19) United States
(12) Patent Application Publication
(10) Pub. No.: US 2010/0223937 A1
(43) Pub. Date: Sep. 9, 2010

(54) Heat Exchanger Coupling Blocking Plug

(75) Inventors: Michel Grabon, Bressolles (FR); Daniel W. Williams, Avon, CT (US); Didier Da Costa, Lyon (FR)

Correspondence Address: BACHMAN & LAPOINTE, P.C. (UTC), 900 CHAPEL STREET, SUITE 1201, NEW HAVEN, CT, 06510-2802, US

(73) Assignee: CARRIER CORPORATION, Farmington, CT (US)

(21) Appl. No.: 12/681,184

(22) PCT Filed: Nov. 28, 2007
(86) PCT No.: PCT/US07/85713

§ 371 Date: Apr. 1, 2010

(51) Int. Cl. F25B 45/00; F28F 1/00; F16L 55/10

(52) U.S. Cl. 62/77; 165/177; 138/89

(57) ABSTRACT

A blocking plug fitting that does not require brazing is described that fits in matching correspondence with an existing fitting arrangement used to couple refrigerant tubing to a heat exchanger. The blocking plug fitting allows a refrigerant system to be returned to service quickly if a heat exchanger is removed for repair.

### BACKGROUND OF THE INVENTION

The invention relates generally to the field of heating, ventilation and air conditioning (HVAC) systems.

A heat pump is a machine that moves heat using a compressor from a low temperature reservoir to a higher temperature reservoir. The pump operates a refrigeration cycle where the refrigerant repeatedly changes state from liquid to vapor, and back to liquid. The refrigerant is condensed to release heat in one part of the cycle and is boiled (evaporated) to absorb heat in another part of the cycle.

Heat pumps use refrigerant to air heat exchangers (air coils) typically made from copper tubes and aluminium fins. Recently, all aluminium coils have been used. These coils are referred to as minichannel or microchannel heat exchangers. The heat exchangers may be assembled in cross-flow section arrangements allowing the refrigerant to flow from one side of the heat exchanger (hot or cold) to the other (cold or hot). Tubing manifolds at each side of a heat exchanger couple individual heat exchangers together and provide connections to the rest of the heat pump circuit. The individual heat exchangers may be arranged in multi-circuits and may couple to refrigerant tubing or piping at two or three interfaces.

Due to refrigerant leaks, it may be necessary to replace or repair a heat exchanger. The refrigerant circuit cannot operate until the section is repaired or replaced and the refrigerant circuit is recharged. Since the repair operation may take several days due to part availability, it may be necessary to plug the refrigerant tubing connections that couple to the leaking heat exchanger to return the system back to operation.

Typically, the refrigerant in the system is evacuated and the damaged heat exchanger is removed. The refrigerant tubing leading to and from the heat exchanger is capped by brazing copper plugs onto the tube ends. The plugs allow the refrigerant circuit to be recharged and the system returned to service, but at a reduced capacity.

### SUMMARY OF THE INVENTION

Exemplary embodiments of the invention include a blocking plug fitting, which include a body having a bore, the bore having an open end and a closed end and having a predefined diameter to receive a tube having an outer diameter in matching correspondence with the bore. The fitting also includes a mechanical fastener for coupling the body with a tubing support block of a tube to be plugged.

Further exemplary embodiments of the invention include a method for returning a refrigeration system back to operation after removing a heat exchanger for service. The method includes evacuating the refrigeration system refrigerant, uncoupling refrigerant tubing that couples to the heat exchanger, plugging the refrigerant tubing using a blocking plug fitting comprising a body having a bore, the bore having an open end and a closed end and having a predefined diameter to receive a refrigerant tube having an outer diameter in matching correspondence with the bore and a mechanical fastener for coupling the body with a refrigerant tubing support block of a refrigerant tube to be plugged, and securing the blocking plug fitting to the refrigerant tubing support block of the refrigerant tube to be plugged.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an exemplary exploded perspective view of a heat exchanger seal washer block fitting, refrigerant tubing end and a tubing support block.

FIG. 2 is an assembled perspective view of a refrigerant tube coupled to a heat exchanger using the block fitting and tubing support block shown in FIG. 1.

FIG. 3 is an exemplary view of the refrigerant tubing end and tubing support block shown in FIG. 1 with a blocking plug fitting.

FIG. 4 is an exemplary view of a group of heat exchanger pairs.

FIG. 5 is an exemplary view of one heat exchanger pair shown in FIG. 4.

### DETAILED DESCRIPTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein if for the purpose of description and should not be regarded as limiting. The use of “including,” “comprising,” or “having,” and variations thereof herein is meant to encompass the items listed thereafter and equivalents thereof as well as additional items. The terms “mounted,” “connected,” and “coupled,” are used broadly and encompass both direct and indirect mounting, connecting, and coupling. Further, “connected,” and “coupled” are not restricted to physical or mechanical connections or couplings.

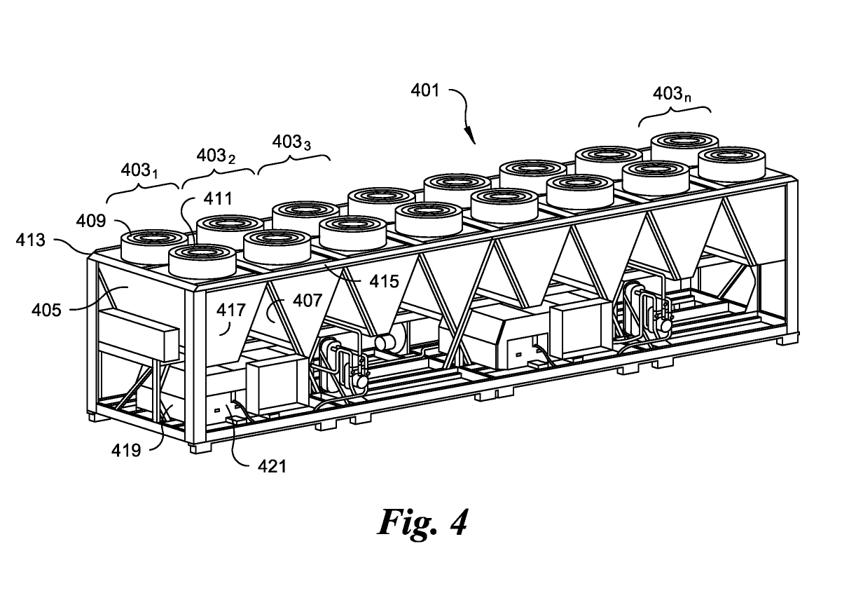

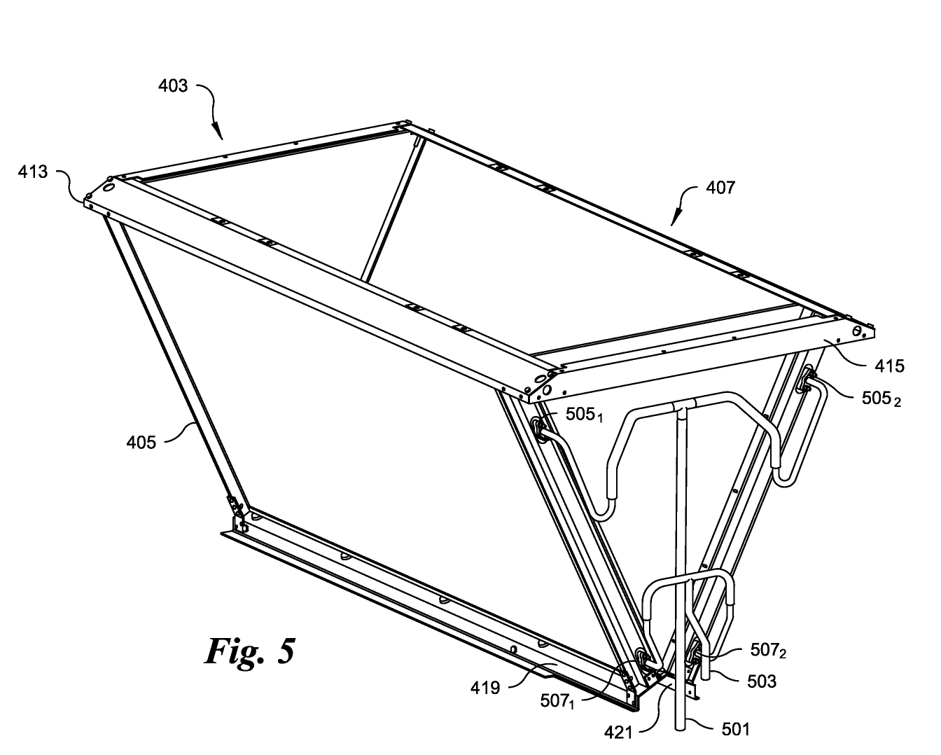

FIG. 4 shows a group 401 of heat exchanger pairs 403₁, 403₂, 403₃, . . . 403ₙ (collectively 403) operating in parallel. A pair 403 of heat exchangers 405 and 407, which may be microchannel heat exchangers (MCHX), are oriented at an acute angle with respect to each other and converge away from two circulation fans 409, 411. The fans 409, 411 are supported by the heat exchangers 405, 407, additional support members 413, 415 and fan motor support brackets (not shown). Solid covers 417 are positioned on the ends and around the circulation fans 409, 411 such that the circulation fans 409, 411 draw air through the exchangers 405, 407. Two drainage channels 419, 421 are provided to collect and guide water run-off 121 from the coils during defrosting cycles.

FIG. 5 shows a heat exchanger pair 403 with the circulation fans 409, 411 and cover 417 removed. Each heat exchanger 405, 407 is coupled to a refrigeration or chiller system by inlet 501 and outlet 503 manifolds. Each inlet 501 and outlet 503 manifold may have several inlet 505₁, 505₂ and outlet 507₁, 507₂ refrigerant tubing connections that couple with a heat exchanger 405, 407.

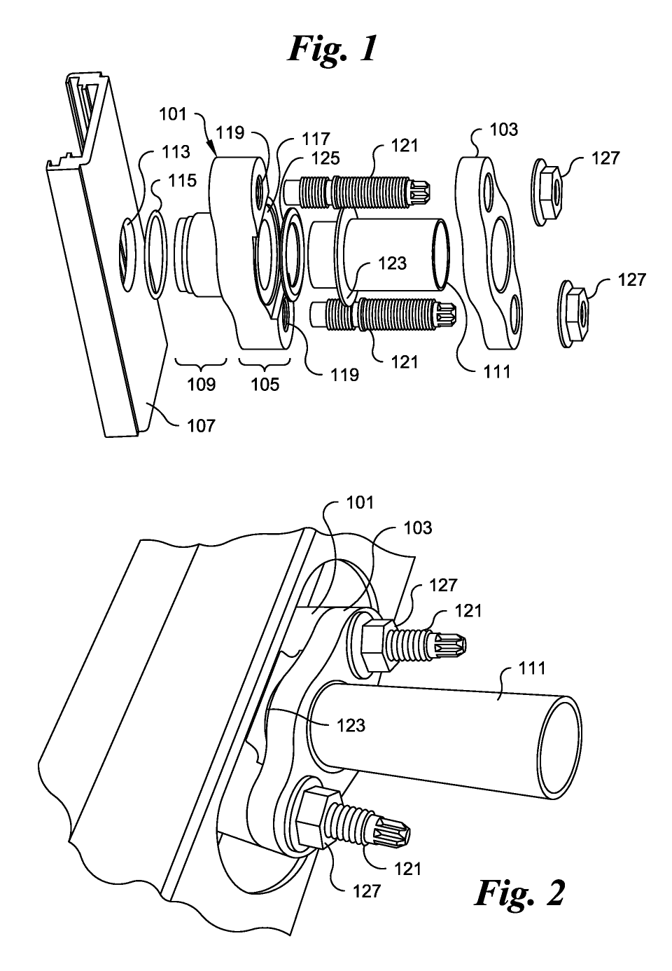

FIGS. 1 and 2 show a tubing connection which may be either an inlet 505₁, 505₂ or outlet 507₁, 507₂ connection. The connection includes a seal washer block heat exchanger fitting 101 and a mating tubing support block fitting 103. The fitting 101 includes a body having a block portion 105 that resides above the exterior surface of a heat exchanger 107 and an insert portion 109 having an outer diameter that is received in the heat exchanger 107. The fitting 101 allows refrigerant to pass from a refrigerant tube 111 in or out of a heat exchanger 107.

The insert portion 109 outer diameter is sized in matching correspondence with an opening 113 on the heat exchanger 107. The insert portion 109 may have an inner diameter sized for receiving the refrigerant tube 111.

A circular seal 115 is disposed around the insert portion 109, between the heat exchanger 107 surface and under the fitting 101 block portion 105. After positioning the fitting 101 and seal 115 onto the heat exchanger 107, the fitting 101 may be brazed onto the heat exchanger 107 to provide a leak-free coupling.

The block portion 105 includes a recessed circular area 117 located between two or more threaded holes 119. Each threaded hole 119 receives a corresponding mounting stud 121. The circular area 117 is sized to receive a seal 125. Two or more mounting studs 121 are threaded into the block portion 105. The fitting 101, seal 115 and mounting studs 121 become part of the heat exchanger 107.

A collar 123 is positioned onto the refrigerant tubing 111 at a predefined distance from the end of the refrigerant tubing end. The collar 123 may be a separate component that is brazed continuously around the refrigerant tubing or may be formed by plastic deformation of the refrigerant tube. The position of the collar 123 is such that the tube penetrating into the block 105 enters to a depth corresponding to 75 percent of the insert portion 109 inner diameter. The position of the collar 123 captures the tubing support block fitting 103. The refrigerant tubing 111 may be any length.

To couple a refrigerant tube 111 to a heat exchanger 107 (fitting 101), a flexible seal 125 such as a compression washer is placed over the end of the refrigerant tube 111, and the refrigerant tube 111 is slide into the block portion 105.

The tubing support block 103 is positioned to align the studs 121 with corresponding holes located in the block portion 103. The tubing support block 103 is slid over the mounting studs 121 and a nut 127, such as a collar nut, for each mounting stud 121 is threaded onto each mounting stud 121 and torqued in accordance with the requirements of the seal 125. The refrigerant tubing 111 collar 123, in conjunction with the tubing support block 103 and nuts 127, compress the seal 125 between the block portion 105 recess 117 and collar 123 to form a leak-proof coupling between the fitting 101 and refrigerant tubing 111. FIG. 2 shows a refrigerant tube coupled to a heat exchanger using the block fitting and tubing support block.

If the heat exchanger 107 needs to be removed from service, after any refrigerant in the tubing and heat exchanger 107 is evacuated, the two or more nuts 127 are removed, breaking the coupling between the refrigerant tubing 111 and heat exchanger 107 (fitting 101). The compression seal 125 is typically discarded. Each heat exchanger 107 seal washer block fitting 101 is broken, freeing the heat exchanger 107 for removal.

To allow heat pump operation while a heat exchanger 107 is being serviced, the refrigerant tubing 111 that is normally coupled to the removed heat exchanger must be plugged, or sealed, to allow the system to be recharged with refrigerant. The heat exchanger may not be removed, but may remain in place while a replacement is ordered.

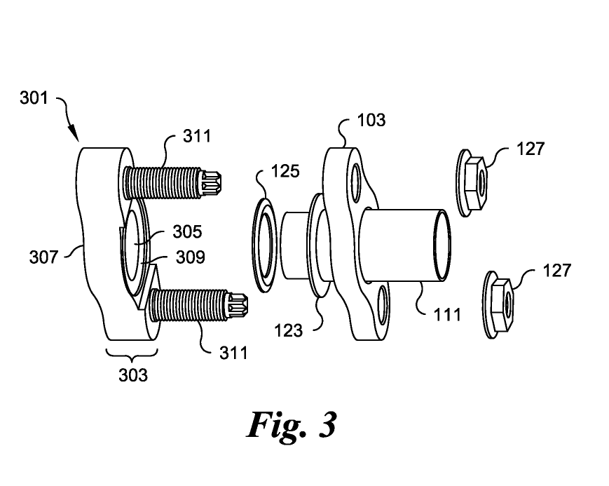

FIG. 3 shows the blocking plug fitting 301. The blocking plug fitting 301 includes a body 303 having a bore 305 having an open end and a closed end 307. The bore has a predefined diameter to receive a tube 111 having an outer diameter in matching correspondence with the bore 305. A recessed circular area 309 around the bore and between two or more studs 311 receives the compression seal 125. The two or more studs 311 are for coupling with the tubing support block 103. The blocking plug fitting 301 is coupled to the tubing support block 103. The blocking plug fitting 301 material may be aluminum, magnesium, bronze, titanium or alloys thereof.

The blocking plug fitting 301 has the same mating geometry as the block fitting 101 corresponding to a refrigerant tube and its associated tubing support block fitting. The seal washer block fitting 101 allows refrigerant to pass freely through its body while the blocking plug fitting 301 does not.

The blocking plug fitting 301 is used to quickly return a chiller or other system using air heat exchangers back to service when one of a plurality of heat exchangers experiences a failure (leak). The refrigerant or operating fluid in the system is evacuated and the inlet and outlet refrigerant tubing connections for the defective heat exchanger are broken (uncoupled). Blocking plug fittings 301 are used to seal the refrigerant tubing ends. After the refrigerant tubing ends are sealed, the system can be recharged and operated at a reduced refrigeration capacity due to the heat exchanger removed from service. The defective heat exchanger may be removed from its physical location at any time.

The advantage of using the block plug fitting 301 is that it allows refrigerant tubing to be capped without requiring brazing. Brazing systems that use aluminum tubing and aluminum heat exchangers is difficult. While the block plug fitting 301 was developed for MCHX, it can be use to block tubing connections for any type of heat exchanger regardless of the material used. A heat exchanger can be removed from service and the tubing ends capped using the block plug fitting 301 to allow the system to be recharged and returned to service, but at a reduced capacity. Service technicians may use several block plug fittings 301 to plug the tubing connections to a heat exchanger 107.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A refrigerant line blocking plug fitting comprising:
a body having a bore, the bore having an open end and a closed end and having a predefined diameter to receive a tube having an outer diameter in matching correspondence with the bore; and
a mechanical fastener for coupling the body with a tubing support block of a tube to be plugged.

2. The fitting according to claim 1 further comprising a recessed circular area around the bore open end.

3. The fitting according to claim 2 further comprising a seal in the recessed circular area.

4. The fitting according to claim 1 wherein the fitting material is selected from the group consisting of aluminum, magnesium, bronze, titanium or alloys thereof.

5. The fitting according to claim 1 wherein the mechanical fastener is two or more studs positioned around the bore open end.

6. The fitting according to claim 1 wherein the mechanical fastener is two or more threaded holes positioned around the bore open end.

7. The fitting according to claim 1 wherein the body matches the shape of the tubing support block.

8. A method for returning a refrigeration system back to operation after removing a heat exchanger for service comprising:
evacuating the refrigeration system refrigerant;
uncoupling refrigerant tubing that couples to the heat exchanger;
plugging the refrigerant tubing using a blocking plug fitting comprising:
a body having a bore, the bore having an open end and a closed end and having a predefined diameter to receive a refrigerant tube having an outer diameter in matching correspondence with the bore; and
a mechanical fastener for coupling the body with a refrigerant tubing support block of a refrigerant tube to be plugged; and
securing the blocking plug fitting to the refrigerant tubing support block of the refrigerant tube to be plugged.

9. The method according to claim 8 wherein the blocking plug fitting further comprises a recessed circular area around the bore open end.

10. The method according to claim 9 further comprising a seal in the recessed circular area.

11. The method according to claim 8 wherein the fitting material is selected from the group consisting of aluminum, magnesium, bronze, titanium or alloys thereof.

12. The method according to claim 8 wherein the mechanical fastener is two or more studs positioned around the bore open end.

13. The method according to claim 8 wherein the mechanical fastener is two or more threaded holes positioned around the bore open end.

14. The method according to claim 8 wherein the body matches the shape of the refrigerant tubing support block.

15. The method according to claim 8 further comprising recharging the refrigeration system with refrigerant.

16. A blocking plug fitting for use with a chiller system comprising:
a body having a bore, the bore having an open end and a closed end and having a predefined diameter to receive a tube having an outer diameter in matching correspondence with the bore;
a mechanical fastener for coupling the body with a tubing support block of a tube to be plugged wherein the body shape corresponds with the tubing support block and the tubing includes a collar located on the outer periphery of the tube between the tubing support block and body.

17. The fitting according to claim 16 comprising a recessed circular area around the bore open end configured to receive a seal.

18. The fitting according to claim 16 wherein the fitting material is selected from the group consisting of aluminum, magnesium, bronze, titanium or alloys thereof.

19. (canceled)

20. (canceled)

21. A combination comprising:
a refrigerant tube; and
a blocking plug of claim 1 mounted to block the refrigerant tube.

22. A chiller system comprising:
the combination of claim 21; and
a heat exchanger having a body having a block portion and two mounting studs and matching a shape of the tubing support block for coupling with the tubing support block when the blocking plug fitting is uncoupled from the tubing support block.
